(19) United States
(12) Patent Application Publication
(10) Pub. No.: US 2013/0335634 A1
(43) Pub. Date: Dec. 19, 2013

(54) NOISE REDUCTION DEVICE AND NOISE REDUCTION METHOD

(71) Applicant: Albert Hua Tai, Hsinchu City (TW)

(72) Inventor: Albert Hua Tai, Hsinchu City (TW)

(73) Assignee: Silicon Integrated Systems Corp., Hsinchu City (TW)

(21) Appl. No.: 13/527,577

(22) Filed: Jun. 19, 2012

(51) Int. Cl. H04N 5/21

(52) U.S. Cl. 348/607

(57) ABSTRACT

A noise reduction device and a noise reduction method are disclosed. The noise reduction device includes a DC removal unit for removing a DC component of a luminance; a first wavelet transform unit for performing a wavelet transform on an output of the DC removal unit for outputting a first low and high band signals; a first low and high band noise estimation units for estimating a first low and high band noise values; a first low and high band soft threshold processing units for forming a first low and high band noise reduction signals according to the first low and high band noise values; and a first inverse wavelet transform unit for performing an inverse wavelet transform on the first low and high band noise reduction signals. The present invention is capable of reducing or removing a noise in the luminance signal.

### TECHNICAL FIELD OF THE INVENTION

The present invention relates to a noise reduction device and method, more particularly, to a noise reduction device and method used for a luminance signal.

### BACKGROUND OF THE INVENTION

In an analog television, a composite video signal of an image comprises a luminance signal (Y) and a chrominance signal (C). A comb filter is commonly used to separate the luminance signal and the chrominance signal from the composite video signal. The process of separating the luminance signal and the chrominance signal is referred to as a Y/C separation.

Reducing a noise in the luminance signal is an important topic in the analog television. Generally, the noise in the luminance signal is reduced or removed by using a filter. However, the filter is not an adaptive device for removing the noise. More particularly, when the effect of reducing or removing the noise is strong, the luminance signal is destroyed as well, that is, an image which contains the luminance signal is blurred. Contrarily, when the effect of reducing or removing the noise is weak, the noise still exists and affects the luminance signal. In conclusion, the filter cannot reduce or remove the noise according to an intensity of the noise.

Therefore, there is a need for a solution to avoid the above-mentioned problem that the noise cannot be removed according to the intensity of the noise.

### SUMMARY OF THE INVENTION

An objective of the present invention is to provide a noise reduction device and method.

In accordance with an aspect of the present invention, a noise reduction device comprises a DC removal unit, a first wavelet transform unit, a first low band noise estimation unit, a first low band soft threshold processing unit, a first high band noise estimation unit, a first high band soft threshold processing unit, and a first inverse wavelet transform unit. A composite video signal of a field of a frame has a luminance signal. The DC removal unit receives the luminance signal and removes a DC component of the luminance signal. The first wavelet transform unit performs a wavelet transform on an output of the DC removal unit for outputting a first low band signal and a first high band signal. The first low band noise estimation unit estimates a first low band noise value of the field of the frame. The first low band soft threshold processing unit forms a first low band noise reduction signal by subtracting the first low band noise value from a positive component of the first low band signal and adding the first low band noise value to a negative component of the first low band signal when an absolute value of the first low band signal is greater than the first low band noise value, or forms the first low band noise reduction signal by setting the first low band signal to be zero when the absolute value of the first low band signal is smaller than the first low band noise value. The first high band noise estimation unit estimates a first high band noise value of the field of the frame. The first high band soft threshold processing unit forms a first high band noise reduction signal by subtracting the first high band noise value from a positive component of the first high band signal and adding the first high band noise value to a negative component of the first high band signal when an absolute value of the first high band signal is greater than the first high band noise value, or forms the first high band noise reduction signal by setting the first high band signal to be zero when the absolute value of the first high band signal is smaller than the first high band noise value. The first inverse wavelet transform unit performs an inverse wavelet transform on the first low band noise reduction signal and the first high band noise reduction signal for outputting a resultant luminance signal.

In accordance with another aspect of the present invention, a composite video signal in a field of a frame has a luminance signal in a noise reduction method. The noise reduction method comprises the following steps: receiving the luminance signal; removing a DC component of the luminance signal; performing a wavelet transform on the luminance signal of which the DC component is removed for outputting a first low band signal and a first high band signal; estimating a first low band noise value of the field of the frame; estimating a first high band noise value of the field of the frame; forming a first low band noise reduction signal by subtracting the first low band noise value from a positive component of the first low band signal and adding the first low band noise value to a negative component of the first low band signal when an absolute value of the first low band signal is greater than the first low band noise value, or forming the first low band noise reduction signal by setting the first low band signal to be zero when the absolute value of the first low band signal is smaller than the first low band noise value; forming a first high band noise reduction signal by subtracting the first high band noise value from a positive component of the first high band signal and adding the first high band noise value to a negative component of the first high band signal when an absolute value of the first high band signal is greater than the first high band noise value, or forming the first high band noise reduction signal by setting the first high band signal to be zero when the absolute value of the first high band signal is smaller than the first high band noise value; and performing an inverse wavelet transform on the first low band noise reduction signal and the first high band noise reduction signal for outputting a resultant luminance signal.

The noise reduction device and the noise reduction method of the present invention are capable of reducing or removing a noise in the luminance signal according to intensity of the noise. Specifically, the noise reduction device and the noise reduction method of the present invention are capable of reducing or removing the noise in the luminance signal by adaptively estimating the noise.

### BRIEF DESCRIPTION OF THE DRAWINGS

The present invention will be described in detail in conjunction with the appending drawings, in which:

FIG. 1 is a schematic diagram showing a noise reduction device according to a first embodiment of the present invention;

FIG. 2 is a schematic showing an embodiment of the first wavelet transform unit in FIG. 1 according to the present invention;

FIG. 3 is a schematic showing an embodiment of the first inverse wavelet transform unit in FIG. 1 according to the present invention;

FIG. 4A is a schematic diagram showing that the first analysis filters in FIG. 2 are orthogonal with each other;

FIG. 4B is a schematic diagram showing that the first synthesis filters in FIG. 3 are orthogonal with each other;

FIG. 5 is a schematic diagram showing a vertical blank timing of National Television System Committee standard;

FIG. 6A is a schematic diagram showing a blank line without a noise;

FIG. 6B is a schematic diagram showing a blank line with a noise;

FIG. 7 is a schematic diagram showing a vertical blank timing of Phase Alternation by Line standard;

FIG. 8 is a schematic diagram showing a block diagram of the first low band noise estimation unit in FIG. 1;

FIG. 9A is a schematic diagram showing a waveform of a luminance signal with a noise;

FIG. 9B is a schematic diagram showing a waveform of the luminance signal which is processed with a wavelet transform and an inverse wavelet transform;

FIG. 10A is a schematic diagram showing a waveform of a low band component of the luminance signal with the noise;

FIG. 10B is a schematic diagram showing a waveform of a high band component of the luminance signal with the noise;

FIG. 11A is a schematic diagram showing a waveform after the low band component of the luminance signal with the noise is processed by the first low band soft threshold processing unit in FIG. 1;

FIG. 11B is a schematic diagram showing a waveform after the high band component of the luminance signal with the noise is processed by the first high band soft threshold processing unit in FIG. 1;

FIG. 12 is a schematic diagram showing a noise reduction device according to a second embodiment of the present invention; and

FIG. 13 is a flow chart showing a noise reduction method according to an embodiment of the present invention.

### DETAILED DESCRIPTION OF THE INVENTION

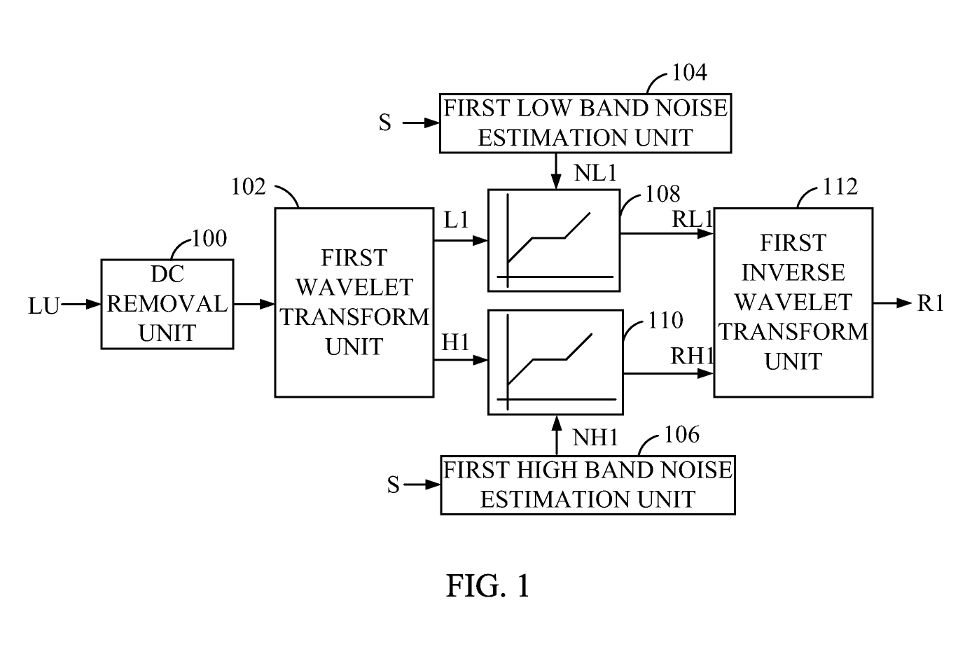

FIG. 1 is a schematic diagram showing a noise reduction device according to a first embodiment of the present invention. The noise reduction device comprises a DC (direct current) removal unit 100, a first wavelet transform unit 102, a first low band noise estimation unit 104, a first high band noise estimation unit 106, a first low band soft threshold processing unit 108, a first high band soft threshold processing unit 110, and a first inverse wavelet transform unit 112.

The DC removal unit 100 receives a luminance signal LU and removes a DC component of the luminance signal LU. A composite video signal in a field of a frame has the luminance signal LU and a chrominance signal (not shown). The luminance signal LU may be a 3D luminance signal generated by a 3D comb filter or a non-3D luminance signal generated by a non-3D comb filter. The 3D and non-3D comb filters are understood by one skilled in the art and omitted herein. The DC removal unit 100 may be a band pass filter or a high pass filter.

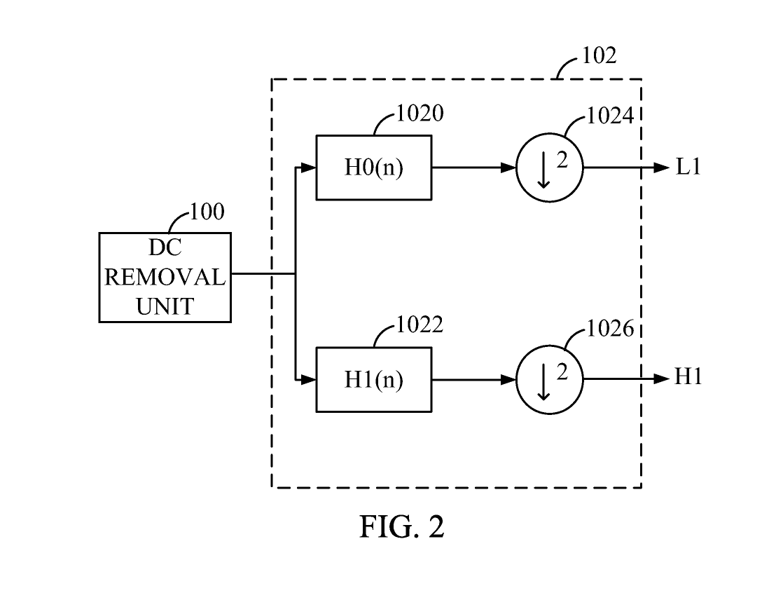

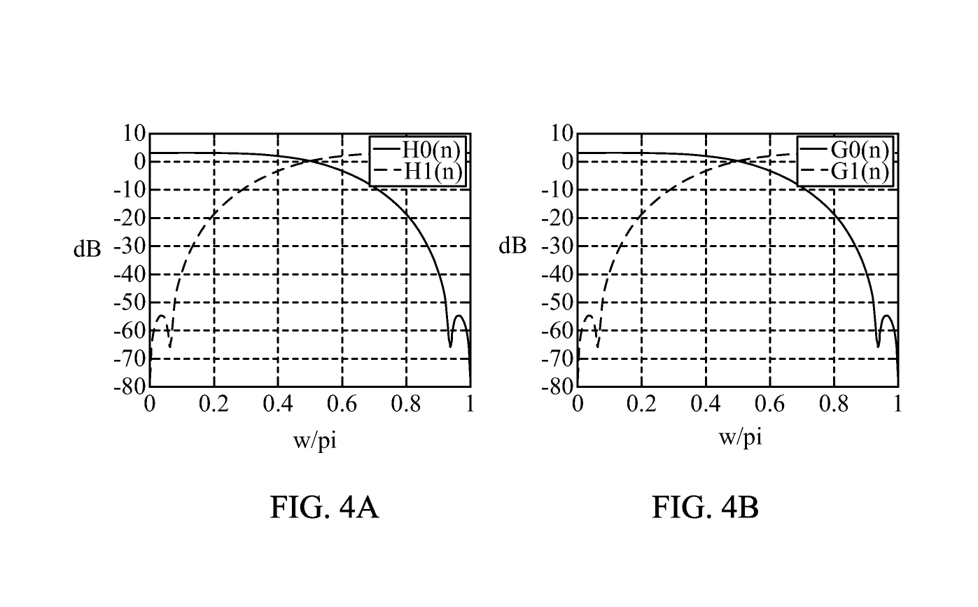

The first wavelet transform unit 102 performs a wavelet transform on an output of the DC removal unit 100 for outputting a first low band signal L1 and a first high band signal H1. Please refer to FIG. 1 and FIG. 2. FIG. 2 is a schematic showing an embodiment of the first wavelet transform unit 102 in FIG. 1 according to the present invention. The first wavelet transform unit 102 comprises two first analysis filters 1020, 1022 and two first downsampling units 1024, 1026. The first analysis filters 1020, 1022 are orthogonal with each other, as shown in FIG. 4A. The first analysis filter 1020 passes a low band component of the output of the DC removal unit 100 and filters out a high band component of the output of the DC removal unit 100. The first analysis filter 1022 passes the high band component of the output of the DC removal unit 100 and filters out the low band component of the output of the DC removal unit 100. The first downsampling unit 1024 is electrically coupled to the first analysis filter 1020 for downsampling an output of the first analysis filter 1020 by a factor of 2 and outputting the first low band signal L1. The first downsampling unit 1026 is electrically coupled to the analysis filter 1022 for downsampling an output of the first analysis filter 1022 by a factor of 2 and outputting the first high band signal H1.

Referring back to FIG. 1, the first low band noise estimation unit 104 estimates and outputs a first low band noise value NL1 of the field of the frame. The first high band noise estimation unit 106 estimates and outputs a first high band noise value NH1 of the field of the frame. More particularly, the first low band noise value NL1 is a noise of a low band component of a signal S, while the first high band noise value NH1 is a noise of a high band component of the signal S. The signal S and the luminance signal LU are in the same field of the frame. The signal S will be described in detail later.

The first low band soft threshold processing unit 108 is electrically coupled to the first wavelet transform unit 102 and the first low band noise estimation unit 104 for performing a soft threshold operation on the first low band signal L1 according to the first low band noise value NL1 and outputting a first low band noise reduction signal RL1. The soft threshold operation means that when an absolute value of the first low band signal L1 is greater than the first low band noise value NL1, the first low band noise reduction signal RL1 is formed by subtracting the first low band noise value NL1 from a positive component of the first low band signal L1 and adding the first low band noise value NL1 to a negative component of the first low band signal L1; when the absolute value of the first low band signal L1 is smaller than the first low band noise value NL1, the first low band noise reduction signal RL1 is formed by setting the first low band signal L1 to be zero.

Specifically, when the first low band signal L1 is greater than the first low band noise value NL1, the first low band soft threshold processing unit 108 reduces the first low band noise value NL1 by subtracting the first low band noise signal NL1 from the positive component of the first low band signal L1 and adding the first low band noise value NL1 to the negative component of the first low band signal L1. When the first low band signal L1 is smaller than the first low band noise value NL1, the first low band soft threshold processing unit 108 reduces the first low band noise value NL1 by setting the first low band signal L1 to be zero, that is, the first low band noise reduction signal RL1 is zero.

In the same manner, the first high band soft threshold processing unit 110 is electrically coupled to the first wavelet transform unit 102 and the first high band noise estimation unit 106 for performing a soft threshold operation on the first high band signal H1 according to the first high band noise value NH1 and outputting a first high band noise reduction signal RH1. When an absolute value of the first high band signal H1 is greater than the first high band noise value NH1, the first high band noise reduction signal RH1 is formed by subtracting the second high band noise value NH1 from a positive component of the first high band signal H1 and adding the second high band noise value NH1 to a negative component of the first high band signal H1; when the absolute value of the first high band signal H1 is smaller than the second high band noise value NH1, the first high band noise reduction signal RH1 is formed by setting the first high band signal H1 to be zero.

Specifically, when the first high band signal H1 is greater than the first high band noise value NH1, the first high band soft threshold processing unit 110 reduces the first high band noise value NH1 by subtracting the first high band noise signal NH1 from the positive component of the first high band signal H1 and adding the first high band noise value NH1 to the negative component of the first high band signal H1. When the first high band signal H1 is smaller than the first high band noise value NH1, the first high band soft threshold processing unit 110 reduces the first high band noise value NH1 by setting the first high band signal H1 to be zero, that is, the first high band noise reduction signal RH1 is zero.

In conclusion, the first low and high band soft threshold processing units 108, 110 are utilized for respectively reducing the first low and high band noise values NL1, NH1 by forcing them to zero.

The first inverse wavelet transform unit 112 is electrically coupled to the first low band soft threshold processing unit 108 and the first high band soft threshold processing unit 110. The first inverse wavelet transform unit 112 performs an inverse wavelet transform on the first low band noise reduction signal RL1 and the first high band noise reduction signal RH1 for outputting a resultant luminance signal R1.

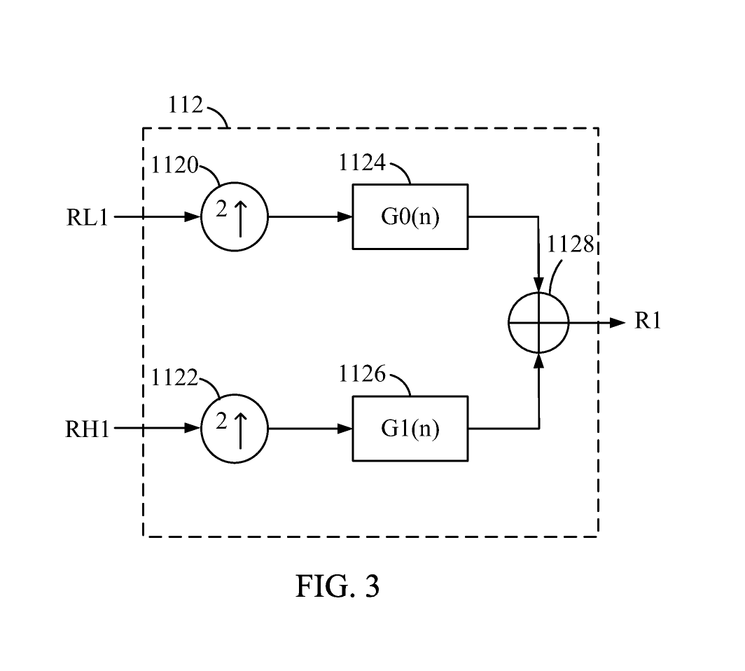

Please refer to FIG. 1 and FIG. 3. FIG. 3 is a schematic showing an embodiment of the first inverse wavelet transform unit 112 in FIG. 1 according to the present invention. The first inverse wavelet transform unit 112 comprises two first upsampling units 1120, 1122, two first synthesis filters 1124, 1126, and a first summing unit 1128. The first synthesis filters 1124, 1126 are orthogonal with each other, as shown in FIG. 4B. The first upsampling unit 1120 is electrically coupled to the first low band soft threshold processing unit 108 for upsampling the first low band noise reduction signal RL1 by a factor of 2. The first upsampling unit 1122 is electrically coupled to the first high band soft threshold processing unit 110 for upsampling the first high band noise reduction signal RH1 by a factor of 2. The first synthesis filter 1124 passes a low band component of an output of the first upsampling filter 1120 and filters out a high band component of the output of the first upsampling filter 1120. The first synthesis filter 1126 passes a high band component of an output of the first upsampling filter 1122 and filters out a low band component of the output of the first upsampling filter 1122. Finally, the first summing unit 1028 sums an output of the first synthesis filter 1124 and an output of the first synthesis filter 1126 to output the resultant luminance signal R1. After the luminance signal LU in FIG. 1 is processed by the present invention, a noise in the resultant luminance signal R1 is removed or reduced.

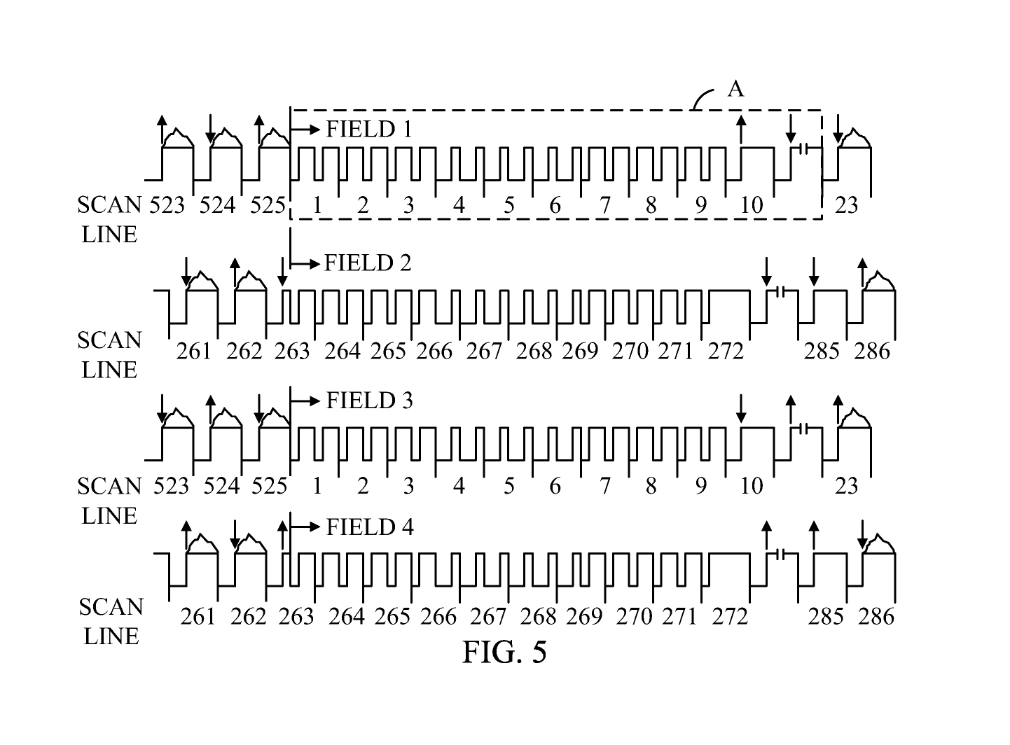

Please refer to FIG. 5. FIG. 5 is a schematic diagram showing a vertical blank timing of National Television System Committee (NTSC) standard. According to NTSC standard, the frame is composed of two fields, and the two fields consist of 262 and 263 scan lines, respectively. Furthermore, NTSC standard defines some scan lines which do not contain data (the data comprises the luminance signal LU in FIG. 1). For example, some scan lines in a blank line area A do not contain data. The scan lines which do not contain data contain vertical-sync, equalizing pulses and so on. For the convenience of description, the scan lines which do not contain data are referred to as blank lines in the following description. It is noted that vertical blanking interval (VBI) signals might appear in some scan lines in the blank line area A, and the VBI signals in some scan lines could not be used in the present invention.

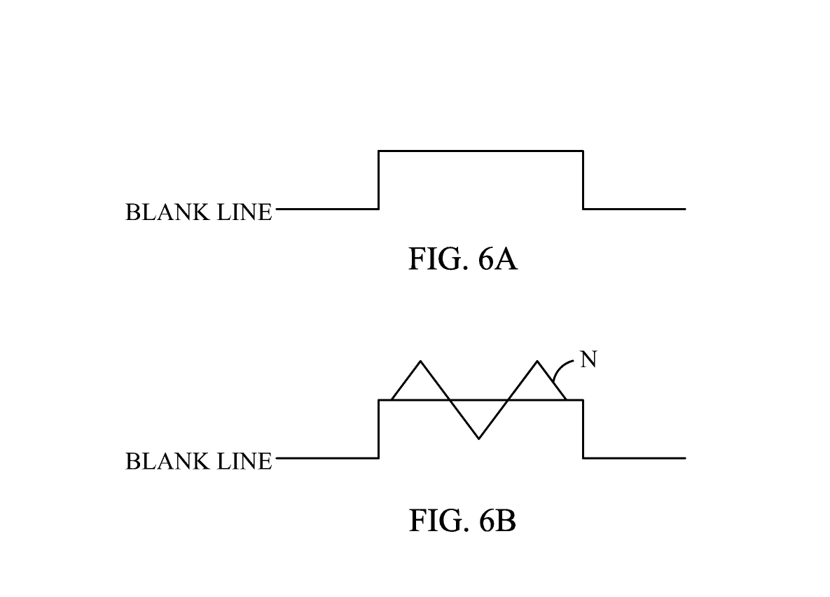

Please refer to FIG. 6A and FIG. 6B. FIG. 6A is a schematic diagram showing a blank line without a noise (i.e. an ideal condition of a blank line), while FIG. 6B is a schematic diagram showing a blank line with a noise N. When the blank line does not contain a noise, the blank line should be flat as shown in FIG. 6A. In contrast, when the blank line contains the noise N, the blank line is not flat as shown in FIG. 6B, that is, any signals may be found in the blank line. The present invention estimates the first low band noise value NL1 and the first high band noise value NH1 in FIG. 1 by observing whether the blank line is flat or not.

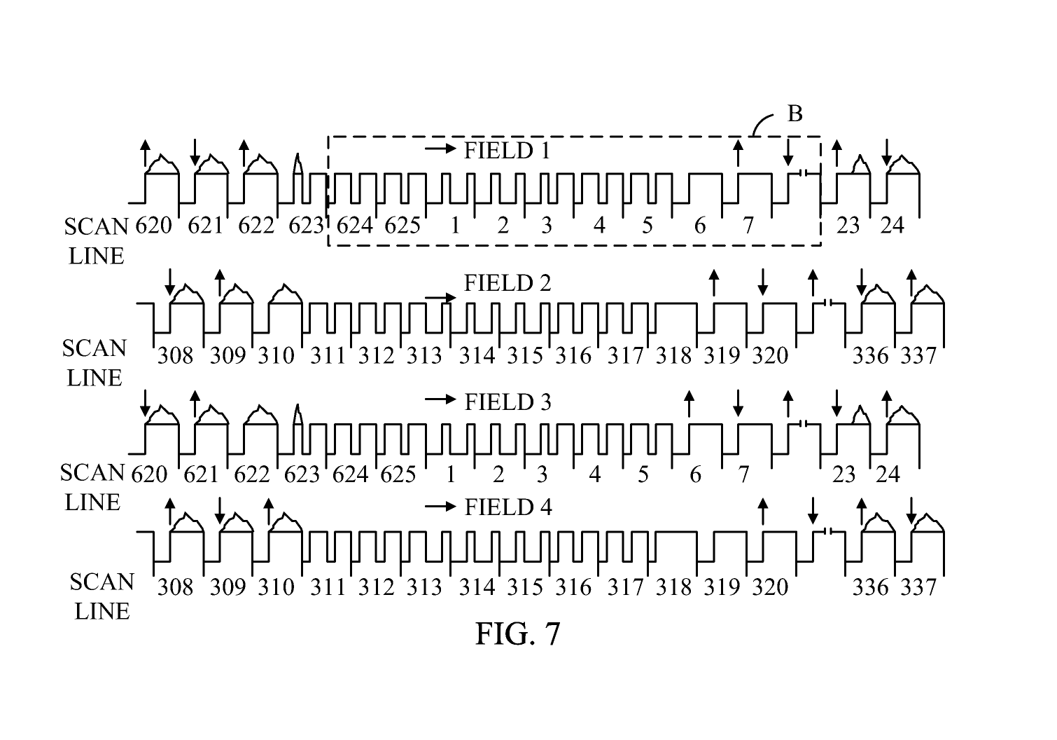

Please refer to FIG. 7. FIG. 7 is a schematic diagram showing a vertical blank timing of Phase Alternation by Line (PAL) standard. The same as NTSC standard, some scan lines in a blank line area B of PAL standard do not contain data. Accordingly, the present invention can estimate the first low band noise value NL1 and the first high band noise value NH1 in FIG. 1 by observing whether at least one of the blank lines of PAL standard is flat or not.

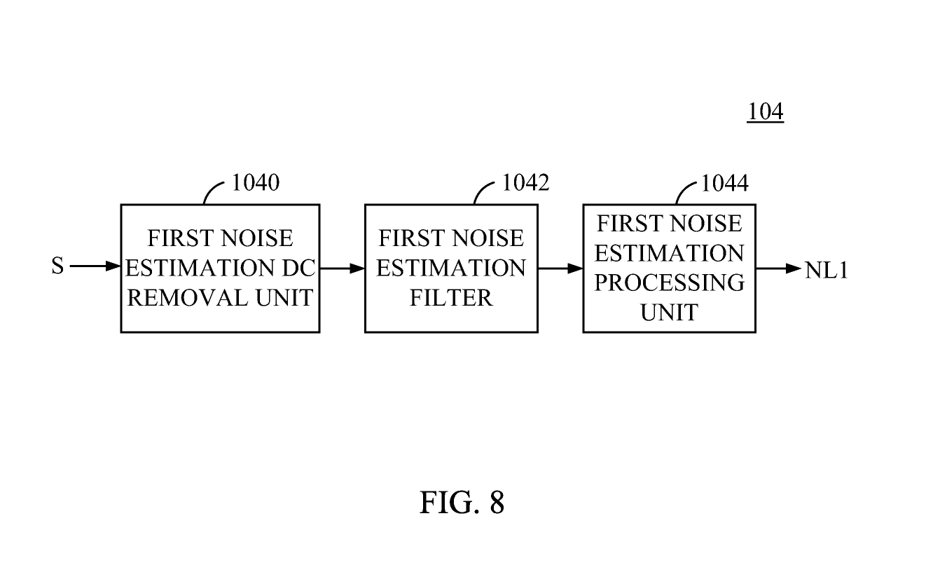

Please refer to FIG. 1 and FIG. 8. FIG. 8 is a schematic diagram showing a block diagram of the first low band noise estimation unit 104 in FIG. 1. The first low band noise estimation unit 104 comprises a first noise estimation DC removal unit 1040, a first noise estimation filter 1042, and a first noise estimation processing unit 1044.

The first noise estimation DC removal unit 1040 receives the signal S in at least one blank line of the field. As mentioned above, the blank line is a scan line without the luminance signal LU. Specifically, the signal S is in the blank line area A in FIG. 5 or in the blank line area B in FIG. 7. The first noise estimation DC removal unit 1040 removes a DC component of the signal S.

The first noise estimation filter 1042 is electrically coupled to the first noise estimation DC removal unit 1040. The first noise estimation filter 1042 passes a low band component of an output of the first noise estimation DC removal unit 1040 and filters out a high band component of the output of the first noise estimation DC removal unit 1040.

The first noise estimation processing unit 1044 is electrically coupled to the first noise estimation filter 1042. The first noise estimation processing unit 1044 estimates a noise of an output of the first noise estimation filter 1042 to generate and output the first low band noise value NL1, i.e. estimates a noise of the blank line. For instance, the first noise estimation processing unit 1044 generates a plurality of absolute values of the output of the first noise estimation filter 1042. Then, the first noise estimation processing unit 1044 finds out a maximum value in an N-point cycle of the field and accumulates a plurality of maximum values in a plurality of N-point cycles of the field. N is a positive integer. A sampling frequency of the luminance signal LU is commonly set as NxFsc, and N-point is depending on the sampling frequency of NxFsc. Fsc is a carrier frequency of the luminance signal LU. A purpose of finding out the maximum value in the N-point cycle of the field is to avoid the absolute values to be small. When the absolute values are too small, the low band noise value NL1 which is estimated by the first noise estimation processing unit 1044 is not accurate. In one embodiment, an infinite impulse response filter may be used for accumulating the maximum values of the field.

The first high band noise estimation unit 106 in FIG. 1 has the same elements as those of the first low band noise estimation unit 104 in FIG. 8 and thus is not repeated herein. A difference between the first low band noise estimation unit 104 and the first high band noise estimation unit 106 is that the first low band noise estimation unit 104 processes the low band component of the signal S while the first high band noise estimation unit 106 processes the high band component of the signal S.

The first noise estimation filter 1042 of the first low band noise estimation unit 104 in FIG. 8 is corresponding to the first analysis filter 1020 in FIG. 2, that is, the first noise estimation filter 1042 in FIG. 8 and the first analysis filter 1020 in FIG. 2 are operated in the same sub band (i.e. the first low band). In the same manner, a first noise estimation filter (not shown) of the first high band noise estimation unit 106 in FIG. 1 and the first analysis filter 1022 in FIG. 2 are operated in the same frequency sub band (i.e. the first high band).

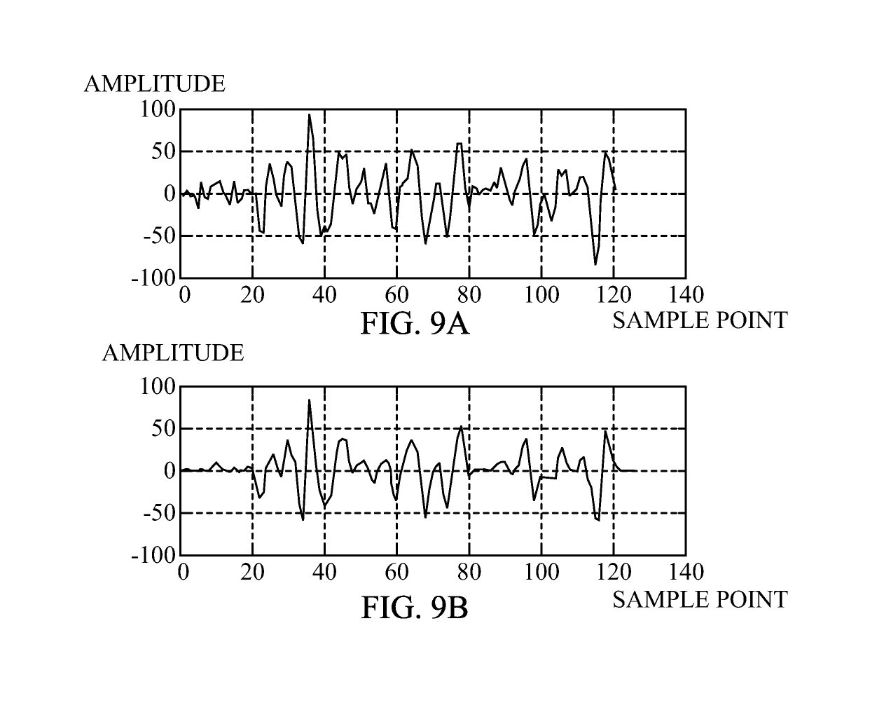

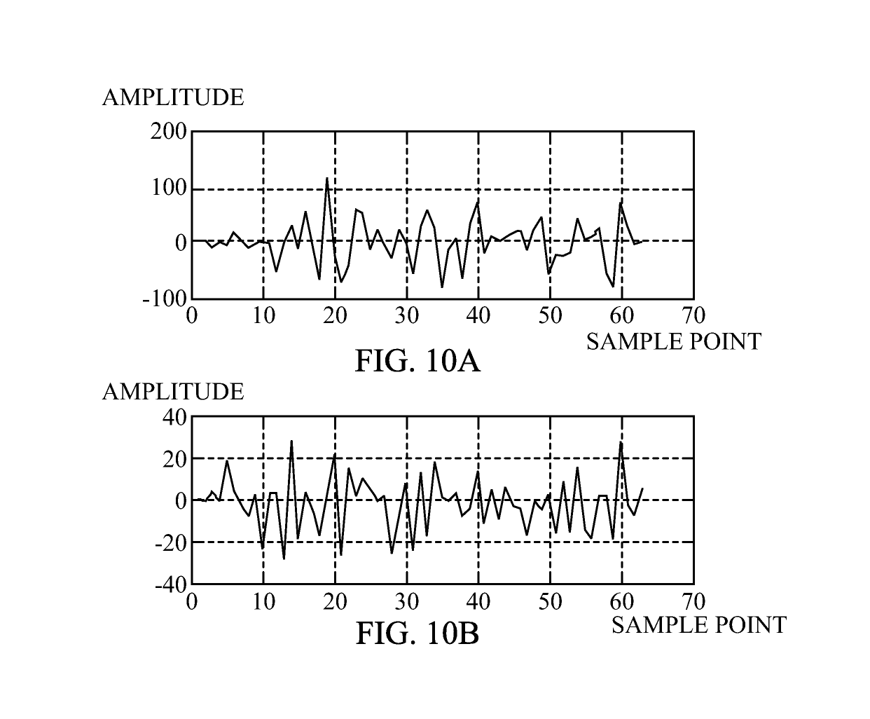

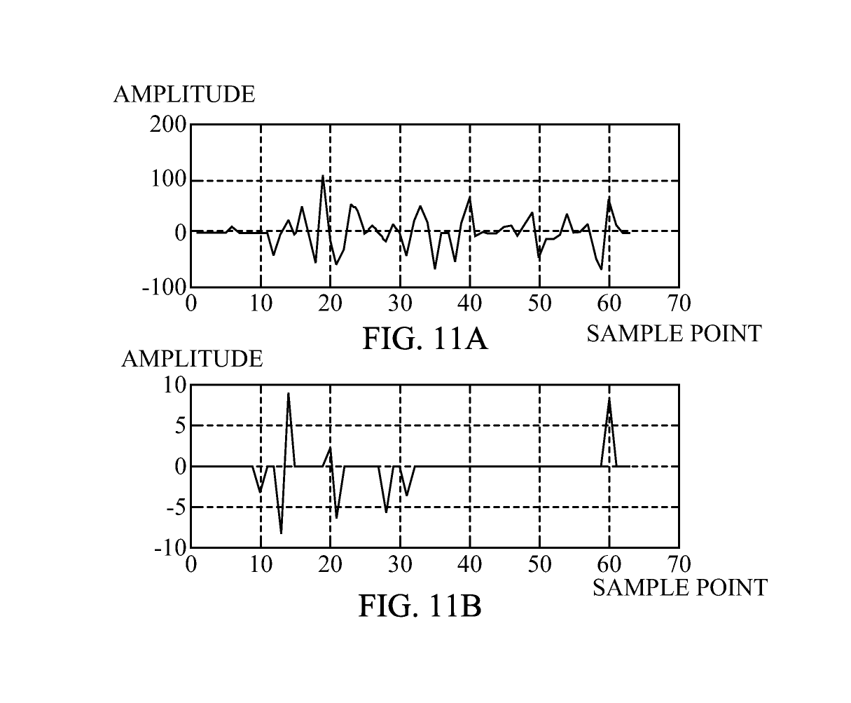

Please refer to FIG. 9A to FIG. 11B. FIG. 9A is a schematic diagram showing a waveform of a luminance signal with a noise, and FIG. 9B is a schematic diagram showing a waveform of the luminance signal which is processed with a wavelet transform and an inverse wavelet transform. FIG. 10A is a schematic diagram showing a waveform of a low band component of the luminance signal with the noise, and FIG. 10B is a schematic diagram showing a waveform of a high band component of the luminance signal with the noise. More particularly, FIG. 10A and FIG. 10B respectively show the waveforms after the output of the DC removal unit 100 in FIG. 1 is processed by the first wavelet transform unit 102. FIG. 11A is a schematic diagram showing a waveform after the low band component of the luminance signal with the noise is processed by the first low band soft threshold processing unit 108 in FIG. 1, and FIG. 11B is a schematic diagram showing a waveform after the high band component of the luminance signal with the noise is processed by the first high band soft threshold processing unit 110 in FIG. 1. For the low band component, amplitudes of some sample points in FIG. 11A are smaller than amplitudes of some sample points in FIG. 10A. This means that the noise in some sample points is reduced. For the high band component, amplitudes of some sample points in FIG. 11B are smaller than amplitudes of some sample points in FIG. 10B. This means that the noise in some sample points is reduced.

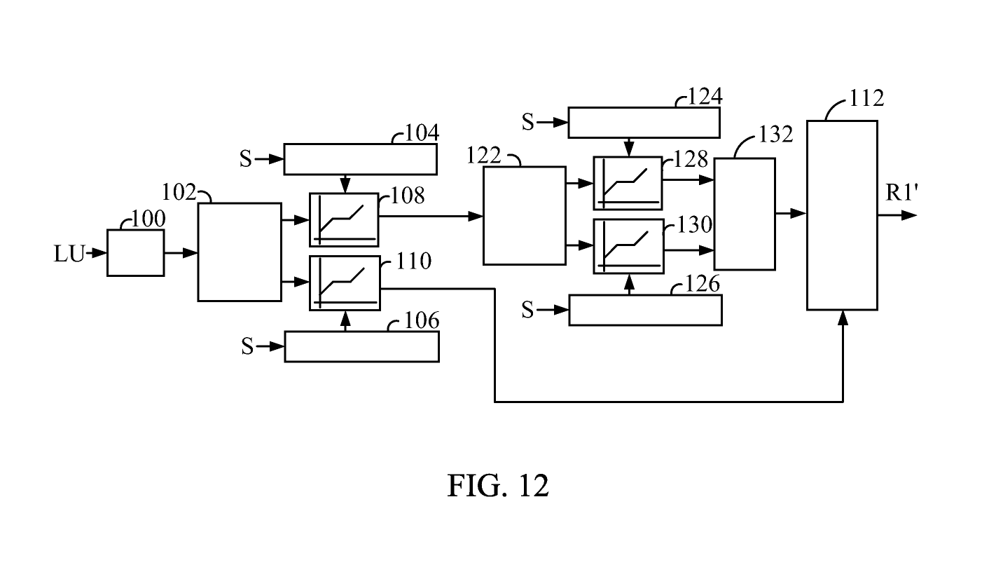

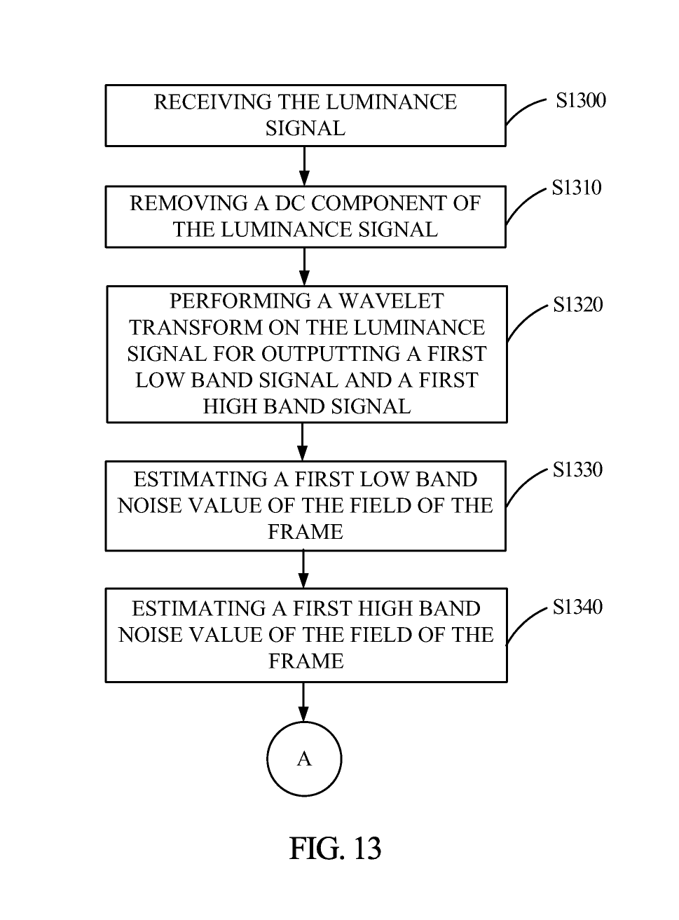

Please refer to FIG. 12. FIG. 12 is a schematic diagram showing a noise reduction device according to a second embodiment of the present invention. Compared with the noise reduction device of the first embodiment in FIG. 1, the noise reduction device of the second embodiment further comprises a second wavelet transform unit 122, a second low band noise estimation unit 124, a second high band noise estimation unit 126, a second low band soft threshold processing unit 128, a second high band soft threshold processing unit 130, and a second inverse wavelet transform unit 132.

In the present embodiment, the second wavelet transform unit 122 performs a wavelet transform on the output of the first low band soft threshold processing unit 108 (i.e. the first low band noise reduction signal RL1 in FIG. 1) for outputting a second low band signal and a second high band signal. Specifically, the first wavelet transform unit 102 divides the luminance signal LU into the first low band signal L1 and the first high band signal H1 in FIG. 1, and the second wavelet transform unit 122 further divides the output of the first low band soft threshold processing unit 108 (i.e. the first low band noise reduction signal RL1 in FIG. 1) into the second low band signal and the second high band signal.

The second low band noise estimation unit 124 and the second high band noise estimation unit 126 function the same as the first low band noise estimation unit 104 and the first high band noise estimation unit 106. The second low band soft threshold processing unit 128 and the first high band soft threshold processing unit 130 function the same as the first low band soft threshold processing unit 108 and the first high band soft threshold processing unit 110. The detailed descriptions may be referred to the first embodiment in FIG. 1 and are not repeated herein.

The second inverse wavelet transform unit 132 performs an inverse wavelet transform on an output of the second low band soft threshold processing unit 128 and an output of the second high band soft threshold processing unit 130. The first inverse wavelet transform unit 112 is electrically coupled to the second inverse wavelet transform unit 132 and the first high band soft threshold processing unit 110. The first inverse wavelet transform unit 112 performs an inverse wavelet transform on an output of the second inverse wavelet transform unit 132 and the output of the first high band soft threshold processing unit 110 for outputting a resultant luminance signal R1′.

In the second embodiment in FIG. 12, the output of the first low band soft threshold processing unit 108 (i.e. the low band component of the luminance signal LU) is further divided into a low band component and a high band component. In another embodiment, an output of the first high band soft threshold processing unit 110 (i.e. the high band component of the luminance signal LU) may be further divided into a low band component and a high band component. In another embodiment, both the output of the first low band soft threshold processing unit 108 and the output of the first high band soft threshold processing unit 110 may respectively divided into a low band component and a high band component.

The luminance signal LU in the first embodiment in FIG. 1 is divided into one stage of sub bands. The luminance signal LU in the second embodiment in FIG. 12 is divided into two stages of sub bands. In summary, the present invention is capable of dividing the luminance signal LU into a plurality of stages of sub bands as required.

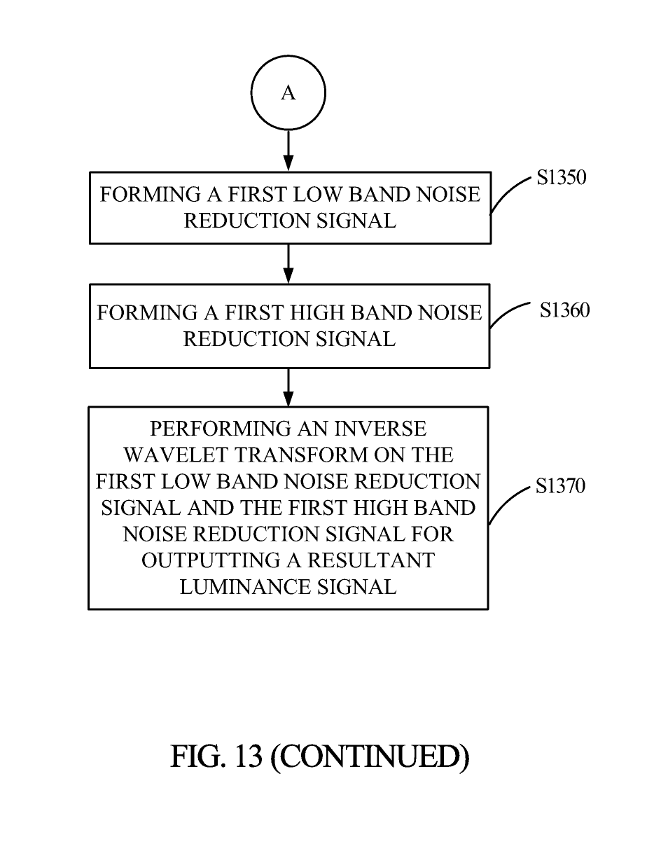

Please refer to FIG. 13. FIG. 13 is a flow chart showing a noise reduction method according to an embodiment of the present invention.

In the noise reduction method, a composite video signal in a field of a frame has a luminance signal and a chrominance signal. The noise reduction method of the present invention comprises the following steps.

In step S1300, the luminance signal is received. The luminance signal may be a 3D luminance signal generated by a 3D comb filter or a non-3D luminance signal generated by a non-3D comb filter.

In step S1310, a DC component of the luminance signal is removed.

In step S1320, a wavelet transform is performed on the luminance signal of which the DC component is removed for outputting a first low band signal and a first high band signal. The present step comprises: passing a low band component of the luminance signal of which the DC component is removed, filtering out a high band component of the luminance signal of which the DC component is removed, and downsampling the low band component of the luminance signal of which the DC component is removed by a factor of 2; and passing the high band component of the luminance of which the DC component is removed, filtering out the low band component of luminance signal of which the DC component is removed, and downsampling the high band component of the luminance signal of which the DC component is removed by a factor of 2.

In step S1330, a first low band noise value of the field of the frame is estimated. The present step comprises: receiving a signal in at least one blank line of the field and removing a DC component of the signal, wherein the blank line of the field is a scan line without the luminance signal; passing a low band component of the signal of which the DC component is removed while filtering out a high band component of the signal of which the DC component is removed; and estimating a noise of the low band component of the signal of which the DC component is removed to generate the first low band noise value.

The step of estimating the noise of the low band component of the signal of which the DC component is removed to generate the first noise value comprises: generating a plurality of absolute values of the low band component of the signal of which the DC component is removed; finding out a maximum value in an N-point cycle of the field; and accumulating a plurality of maximum values in the a plurality of N-point cycles of the field, N is a positive integer. N-point is depending on a sampling frequency of the luminance signal.

In step S1340, a first high band noise value of the field of the frame is estimated. The present step comprises: receiving the signal in the at least one blank line of the field and removing a DC component of the signal, wherein the blank line of the field is a scan line without the luminance signal; passing a high band component of the signal of which the DC component is removed while filtering out a low band component of the signal of which the DC component is removed; and estimating a noise of the high band component of the signal of which the DC component is removed to generate the first high band noise value.

The step of estimating the noise of the high band component of the signal of which the DC component is removed to generate the first high band noise value comprises: generating a plurality of absolute values of the high band component of the signal of which the DC component is removed; finding out a maximum value in an N-point cycle of the field; and accumulating a plurality of maximum values in a plurality of N-point cycles of the field, N is a positive integer. N-point is depending on the sampling frequency of the luminance signal.

In step S1350, a first low band noise reduction signal is formed by subtracting the first low band noise value from a positive component of the first low band signal and adding the first low band noise value to a negative component of the first low band signal when an absolute value of the first low band signal is greater than the first low band noise value, or the first low band noise reduction signal is formed by setting the first low band signal to be zero when the absolute value of the first low band signal is smaller than the first low band noise value.

In step S1360, a first high band noise reduction signal is formed by subtracting the first high band noise value from a positive component of the first high band signal and adding the first high band noise value to a negative component of the first high band signal when an absolute value of the first high band signal is greater than the first high band noise value, or the first high band noise reduction signal is formed by setting the first high band signal to be zero when the absolute value of the first high band signal is smaller than the first high band noise value.

In step S1370, an inverse wavelet transform is performed on the first low band noise reduction signal and the first high band noise reduction signal for outputting a resultant luminance signal. The present step comprises: upsampling the first low band noise reduction signal by a factor of 2, passing a low band component of the first low band noise reduction signal which is upsampled by a factor of 2, and filtering out a high band component of the low band noise reduction signal which is upsampled by a factor of 2; upsampling the first high band noise reduction signal by a factor of 2, passing a high band component of the first high band noise reduction signal which is upsampled by a factor of 2, and filtering out a low band component of the first high band noise reduction signal which is upsampled by a factor of 2; and summing the low band component of the first low band noise reduction signal which is upsampled by a factor of 2 and the high band component of the first high band noise reduction signal which is upsampled by a factor of 2 to output the resultant luminance signal.

The noise reduction device and the noise reduction method according to the present invention are capable of reducing or removing the noise in the luminance signal according to intensity of the noise. When the noise is strong, the present invention strongly reduces the noise. When the noise is weak, the present invention slightly reduces the noise. As a result, an objective of reducing or removing the noise in the luminance signal by adaptively estimating the noise is achieved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A noise reduction device, a composite video signal of a field of a frame having a luminance signal, the noise reduction device comprising:
a DC removal unit, receiving the luminance signal and removing a DC component of the luminance signal;
a first wavelet transform unit, performing a wavelet transform on an output of the DC removal unit for outputting a first low band signal and a first high band signal;
a first low band noise estimation unit, estimating a first low band noise value of the field of the frame;
a first low band soft threshold processing unit, forming a first low band noise reduction signal by subtracting the first low band noise value from a positive component of the first low band signal and adding the first low band noise value to a negative component of the first low band signal when an absolute value of the first low band signal is greater than the first low band noise value, or forming the first low band noise reduction signal by setting the first low band signal to be zero when the absolute value of the first low band signal is smaller than the first low band noise value;
a first high band noise estimation unit, estimating a first high band noise value of the field of the frame;
a first high band soft threshold processing unit, forming a first high band noise reduction signal by subtracting the first high band noise value from a positive component of the first high band signal and adding the first high band noise value to a negative component of the first high band signal when an absolute value of the first high band signal is greater than the first high band noise value, or forming the first high band noise reduction signal by setting the first high band signal to be zero when the absolute value of the first high band signal is smaller than the first high band noise value; and
a first inverse wavelet transform unit, performing an inverse wavelet transform on the first low band noise reduction signal and the first high band noise reduction signal for outputting a resultant luminance signal.

2. The noise reduction device of claim 1, wherein the DC removal unit is a band pass filter or a high pass filter.

3. The noise reduction device of claim 1, wherein the first wavelet transform unit comprises:
two first analysis filters; and
two first downsampling units,
wherein one of the first analysis filters passes a low band component of the output of the DC removal unit and filters out a high band component of the output of the DC removal unit, the other one of the first analysis filters passes the high band component of the output of the DC removal unit and filters out the low band component of the output of the DC removal unit, one of the first downsampling units downsamples an output of one of the first analysis filters by a factor of 2 and outputs the first low band signal, and the other one of the first downsampling units downsamples an output of the other one of the first analysis filters by a factor of 2 and outputs the first high band signal.

4. The noise reduction device of claim 1, wherein the first low band noise estimation unit comprises:
a first noise estimation DC removal unit, receiving a signal in at least one blank line of the field and removing a DC component of the signal, wherein the blank line of the field is a scan line without the luminance signal;
a first noise estimation filter, passing a low band component of an output of the first noise estimation DC removal unit while filtering out a high band component of the output of the first noise estimation DC removal unit; and
a first noise estimation processing unit, estimating a noise of an output of the first noise estimation filter to generate the first low band noise value.

5. The noise reduction device of claim 4, wherein the first noise estimation processing unit estimates the noise of the output of the first noise estimation filter by generating a plurality of absolute values of the output of the first noise estimation filter, finding out a maximum value in an N-point cycle of the field, accumulating a plurality of maximum values in a plurality of N-point cycles of the field, N is a positive integer.

6. The noise reduction device of claim 5, wherein N-point is depending on a sampling frequency of the luminance signal.

7. The noise reduction device of claim 1, wherein the first high band noise estimation unit comprises:
a first noise estimation DC removal unit, receiving a signal in at least one blank line of the field and removing a DC component of the signal, wherein the blank line of the field is a scan line without the luminance signal;
a first noise estimation filter, passing a high band component of an output of the first noise estimation DC removal unit while filtering out a low band component of the output of the first noise estimation DC removal unit; and
a first noise estimation processing unit, estimating a noise of an output of the first noise estimation filter to generate the first high band noise value.

8. The noise reduction device of claim 7, wherein the first noise estimation processing unit estimates the noise of the output of the first noise estimation filter by generating a plurality of absolute values of the output of the first noise estimation filter, finding out a maximum value in an N-point cycle of the field, accumulating a plurality of maximum values in a plurality of N-point cycles of the field, N is a positive integer.

9. The noise reduction device of claim 8, wherein N-point is depending on a sampling frequency of the luminance signal.

10. The noise reduction device of claim 1, wherein the first inverse wavelet transform unit comprises:
two first upsampling units;
two first synthesis filters; and
a first summing unit,
wherein one of the first upsampling units upsamples the first low band noise reduction signal by a factor of 2, the other one of the upsampling units up samples the first high band noise reduction signal by a factor of 2, one of the first synthesis filters passes a low band component of an output of one of the upsampling filters and filters out a high band component of one of the output of the upsampling filters, the other one of the synthesis filters passes a high band component of an output of the other one of the up sampling filters and filters out a low band component of the output of the other one of the upsampling filters, and the first summing unit sums outputs of the synthesis filters to output the resultant luminance signal.

11. A noise reduction method, a composite video signal in a field of a frame having a luminance signal, the noise reduction method comprising:
receiving the luminance signal;
removing a DC component of the luminance signal;
performing a wavelet transform on the luminance signal of which the DC component is removed for outputting a first low band signal and a first high band signal;
estimating a first low band noise value of the field of the frame;
estimating a first high band noise value of the field of the frame;
forming a first low band noise reduction signal by subtracting the first low band noise value from a positive component of the first low band signal and adding the first low band noise value to a negative component of the first low band signal when an absolute value of the first low band signal is greater than the first low band noise value, or forming the first low band noise reduction signal by setting the first low band signal to be zero when the absolute value of the first low band signal is smaller than the first low band noise value;
forming a first high band noise reduction signal by subtracting the first high band noise value from a positive component of the first high band signal and adding the first high band noise value to a negative component of the first high band signal when an absolute value of the first high band signal is greater than the first high band noise value, or forming the first high band noise reduction signal by setting the first high band signal to be zero when the absolute value of the first high band signal is smaller than the first high band noise value; and
performing an inverse wavelet transform on the first low band noise reduction signal and the first high band noise reduction signal for outputting a resultant luminance signal.

12. The noise reduction method of claim 11, wherein the step of performing the wavelet transform on the luminance signal of which the DC component is removed for outputting the first low band signal and the first high band signal comprises:
passing a low band component of the luminance signal of which the DC component is removed, filtering out a high band component of the luminance signal of which the DC component is removed, and downsampling the low band component of the luminance signal of which the DC component is removed by a factor of 2; and
passing the high band component of the luminance of which the DC component is removed, filtering out the low band component of luminance signal of which the DC component is removed, and downsampling the high band component of the luminance signal of which the DC component is removed by a factor of 2.

13. The noise reduction method of claim 11, wherein the step of estimating the first low band noise value of the field of the frame comprises:
receiving a signal in at least one blank line of the field and removing a DC component of the signal, wherein the blank line of the field is a scan line without the luminance signal;
passing a low band component of the signal of which the DC component is removed while filtering out a high band component of the signal of which the DC component is removed; and
estimating a noise of the low band component of the signal of which the DC component is removed to generate the first low band noise value.

14. The noise reduction method of claim 13, wherein the step of estimating the noise of the low band component of the signal of which the DC component is removed to generate the first noise value comprises:
generating a plurality of absolute values of the low band component of the signal of which the DC component is removed;
finding out a maximum value in an N-point cycle of the field; and
accumulating a plurality of maximum values in a plurality of N-point cycles of the field, N is a positive integer.

15. The noise reduction method of claim 14, wherein N-point is depending on a sampling frequency of the luminance signal.

16. The noise reduction method of claim 11, wherein the step of estimating the first high band noise value of the field of the frame comprises:
receiving a signal in at least one blank line of the field and removing a DC component of the signal, wherein the blank line of the field is a scan line without the luminance signal;
passing a high band component of the signal of which the DC component is removed while filtering out a low band component of the signal of which the DC component is removed; and
estimating a noise of the high band component of the signal of which the DC component is removed to generate the first high band noise value.

17. The noise reduction method of claim 16, wherein the step of estimating the noise of the high band component of the signal of which the DC component is removed to generate the first high band noise value comprises:
generating a plurality of absolute values of the high band component of the signal of which the DC component is removed;
finding out a maximum value in an N-point cycle of the field; and
accumulating a plurality of maximum values in a plurality of N-point cycles of the field, N is a positive integer.

18. The noise reduction method of claim 17, wherein N-point is depending on a sampling frequency of the luminance signal.

19. The noise reduction method of claim 11, wherein the step of performing the inverse wavelet transform on the first low band noise reduction signal and the first high band noise reduction signal for outputting the resultant luminance signal comprises:
upsampling the first low band noise reduction signal by a factor of 2, passing a low band component of the first low band noise reduction signal which is upsampled by a factor of 2, and filtering out a high band component of the low band noise reduction signal which is upsampled by a factor of 2;
upsampling the first high band noise reduction signal by a factor of 2, passing a high band component of the first high band noise reduction signal which is upsampled by a factor of 2, and filtering out a low band component of the first high band noise reduction signal which is upsampled by a factor of 2; and
summing the low band component of the first low band noise reduction signal which is upsampled by a factor of 2 and the high band component of the first high band noise reduction signal which is upsampled by a factor of 2 to output the resultant luminance signal.
